(19) United States
(12) Patent Application Publication
(10) Pub. No.: US 2012/0216705 A1
(43) Pub. Date: Aug. 30, 2012

(54) METHODS FOR DISSOLVING POLYMERS USING MIXTURES OF DIFFERENT IONIC LIQUIDS AND COMPOSITIONS COMPRISING THE MIXTURES

(75) Inventors: Robin D. Rogers, Tuscaloosa, AL (US); Daniel T. Daly, Tuscaloosa, AL (US); Gabriela Gurau, Tuscaloosa, AL (US)

(73) Assignee: THE BOARD OF TRUSTEES OF THE UNIVERSITY OF ALABAMA, Tuscaloosa, AL (US)

(21) Appl. No.: 13/505,323

(22) PCT Filed: Nov. 4, 2010
(86) PCT No.: PCT/US10/55381

§ 371 Date: May 1, 2012

Related U.S. Application Data
(60) Provisional application No. 61/257,992, filed on Nov. 4, 2009.

(51) Int. Cl. B01F 1/00; C08K 5/47; C08K 5/3415; C08K 5/3445; C08K 5/3472

(52) U.S. Cl. 106/162.2; 106/163.01; 106/206.1; 106/287.2; 106/287.26; 106/287.3

(57) ABSTRACT

Disclosed are methods for dissolving biopolymers and synthetic polymers using mixtures of different ionic liquids and compositions comprising the mixture. The methods involve contacting a polymer with a mixture of ionic liquids to provide a composition of polymer and the mixture; the mixture of ionic liquids is prepared by either mixing ionic liquids or by a process comprising reacting ionic liquid precursors in one-pot to form the ionic liquids.

### CROSS REFERENCE TO RELATED APPLICATIONS

This application claims the benefit of priority to U.S. Provisional Application 61/257,992, filed Nov. 4, 2009, which is incorporated by reference herein in its entirety.

### FIELD

This disclosure generally relates to methods for dissolving polymers, such as biopolymers or synthetic polymers, using mixtures of ionic liquids having different cations and/or anions and to compositions comprising the mixtures.

### BACKGROUND

Ionic liquids are desirable for use in a number of applications because of their low environmental impact, ease of processing, and cost, among other attributes. However, compositions comprising only a single ionic liquid can be expensive to synthesize and difficult to purify. Thus, there is a need for new ionic liquid compositions that minimize common disadvantages encountered with single ionic liquid compositions. These needs and other needs are addressed by the present invention.

### SUMMARY

In accordance with the purposes of the disclosed materials, compounds, compositions, articles, devices, and methods, as embodied and broadly described herein, the disclosed subject matter, in one aspect, relates to methods for dissolving polymers, such as biopolymers or synthetic polymers, using mixtures of ionic liquids having different cations and/or anions and to compositions comprising the mixtures.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is a flowsheet diagram for one-pot synthesis of ionic liquid statistical mixtures.

FIG. 2 is a thermogravimetric analysis (TGA) plot showing traces of 2:1:1 mixtures of 1-ethyl-3-methylimidazolium, 1,3-diethylimidazolium, and 1,3-dimethylimidazolium acetate (dotted line) and 1-butyl-3-methylimidazolium, 1,3-dibutylimidazolium, and 1,3-dimethylimidazolium acetate (solid line).

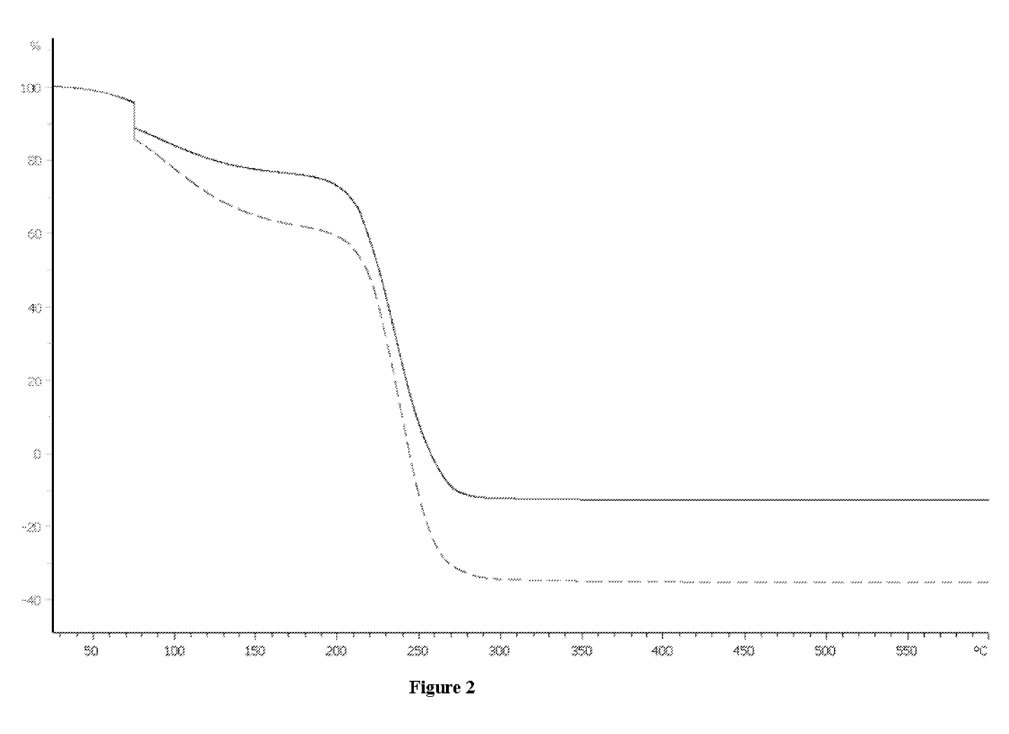

FIG. 3 is a differential scanning calorimetry (DSC) plot showing traces of 2:1:1 mixtures of 1-ethyl-3-methylimidazolium, 1,3-diethylimidazolium, and 1,3-dimethylimidazolium acetate (dotted line) and 1-butyl-3-methylimidazolium, 1,3-dibutylimidazolium, and 1,3-dimethylimidazolium acetate (solid line).

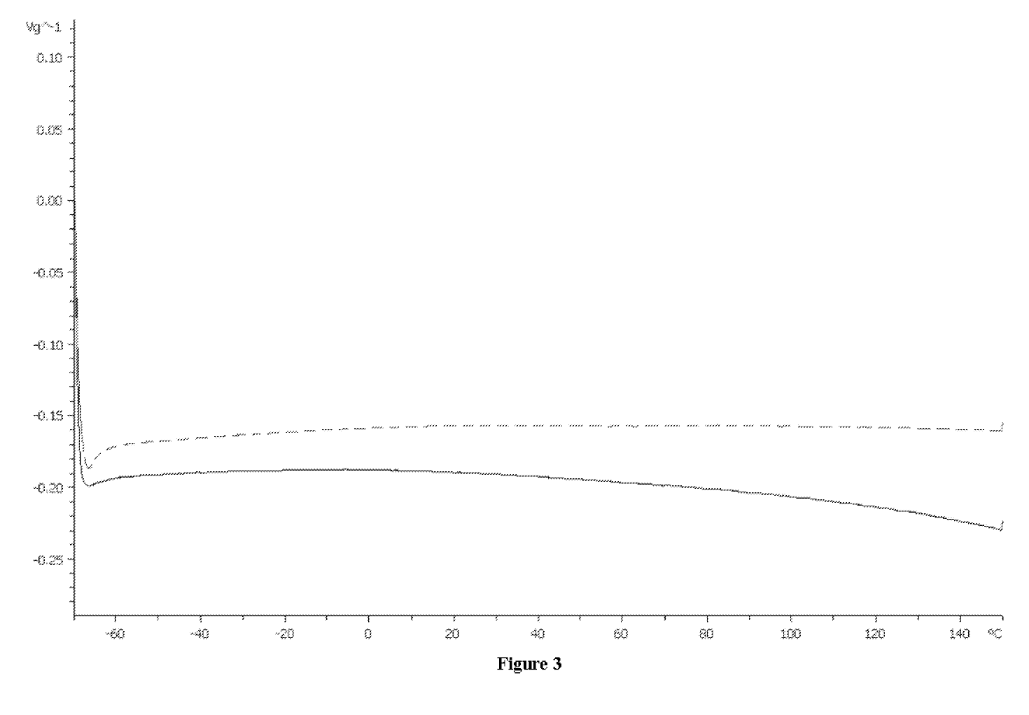

FIG. 4 is a ¹H NMR plot showing a comparison of ¹H NMR of 2:1:1 mixture of 1-ethyl-3-methylimidazolium, 1,3-diethylimidazolium, and 1,3-dimethylimidazolium acetate before (bottom line) and after (top line) cellulose dissolution.

FIG. 5 is a ¹³C NMR plot showing a comparison of ¹³C NMR of 2:1:1 mixture of 1-ethyl-3-methylimidazolium, 1,3-diethylimidazolium, and 1,3-dimethylimidazolium acetate before (top line) and after (bottom line) cellulose dissolution.

### DETAILED DESCRIPTION

The materials, compounds, compositions, articles, devices, and methods described herein may be understood more readily by reference to the following detailed description of specific aspects of the disclosed subject matter and the Examples included therein and to the Figures.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “a polymer” includes mixtures of two or more such polymers, reference to “the component” includes mixtures of two or more such component, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that this data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The terms “amine” or “amino” as used herein are represented by the formula NA¹A²A³, where A¹, A², and A³ can be, independently, hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “carboxylic acid” as used herein is represented by the formula —C(O)OH. A “carboxylate” as used herein is represented by the formula —C(O)O⁻. An acetate or (OAc) is CH₃C(O)O⁻. Throughout the specification C(O) is used as an abbreviation for a carbonyl group.

The term “ester” as used herein is represented by the formula —OC(O)A¹ or —C(O)OA¹, where A¹ can be an alkyl, halogenated alkyl, alkenyl, alkynyl, aryl, heteroaryl, cycloalkyl, cycloalkenyl, heterocycloalkyl, or heterocycloalkenyl group described above.

The term “halide” as used herein refers to the halogens fluorine, chlorine, bromine, and iodine.

The term “hydroxyl” as used herein is represented by the formula —OH.

“R¹,” “R²,” “R³,” “Rⁿ,” where n is an integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an alkyl group, a halide, and the like. Depending upon the groups that are selected, a first group can be incorporated within second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture.

Reference will now be made in detail to specific aspects of the disclosed materials, compounds, compositions, articles, and methods, examples of which are illustrated in the accompanying Examples and Figures.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., (Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplementals (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Also, disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components A, B, and C are disclosed as well as a class of components D, E, and F and an example of a composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

Methods for Dissolving Polymers

The disclosed ionic liquid mixtures can be useful in dissolving and/or processing a polymer. The disclosed processes can be used in a wide variety of applications including synthesis of platform and commodity chemicals, materials, and production of energy. In one aspect, the method comprises contacting a polymer with a mixture of ionic liquids to provide a composition of polymer and the mixture; wherein the polymer is a biopolymer or synthetic polymer; wherein the mixture of ionic liquids comprises ionic liquids having different cations and/or anions; and processing the composition from step under conditions effective to at least partially dissolve the polymer in the mixture.

Various processing methods can be used to dissolve the polymer. In some aspects, the polymer can be simply dissolved in the mixture of ionic liquids to form a composition at room temperature with agitation, such as stirring, and/or using microwave irradiation. In other aspects, the composition can be cooled or heated at a temperature effective for dissolving the polymer in the mixture, for example, from about 0° C. to about 250° C., from about 0° C. to about 120° C., from about 40° C. to about 120° C., from about 80° C. to about 120° C. In some aspects, the composition is not processed at a temperature above 120° C. The composition can also be mechanically or otherwise processed to aid in the dissolution of the polymer. For example, the composition can be agitated, stirred, shaken, irradiated with microwaves, infrared, or ultrasound irradiation, and/or other external sources of energy supply, or otherwise processed. Any processing time can be used to get the polymer to at least partially dissolve in the mixture, for example from a few minutes to hours, such as from 1 to 16 hours, 1 to 12 hours, or from 1 to 5 hours.

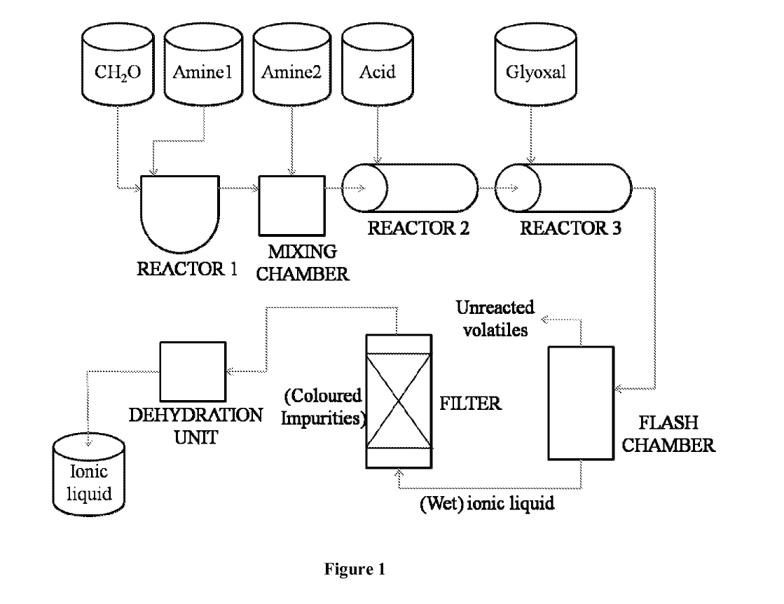

In some aspects, the polymer dissolution methods utilize ionic liquid mixtures prepared by admixing different ionic liquids or by preparing the different ionic liquids using a one-pot synthesis. When a one-pot synthesis is used, the ionic liquid mixture can be purified or unpurified following the synthesis. For example, color can be removed from the ionic liquid mixture prior to use, but such a step is not required. It was observed the elimination of colored impurities had no effect on the amount of cellulose of chitin, exemplary polymers, dissolved, discussed in Examples 4 and 5 below. Thus, in some aspects, the cost of production can be further lowered by using crude mixtures of ionic liquids as solvents for dissolution. To that end, it will be apparent that, unlike the single cation ionic liquids, the disclosed ionic liquid mixtures can, in some aspects, be prepared in a one-pot, single step process using aqueous, readily available, cheap raw materials, therefore reducing or even eliminating the use of the organic solvents in the process. In some aspects, the one-pot synthesis is amenable to a continuous process, such as the one depicted in FIG. 1, which can potentially decrease the cost of manufacturing.

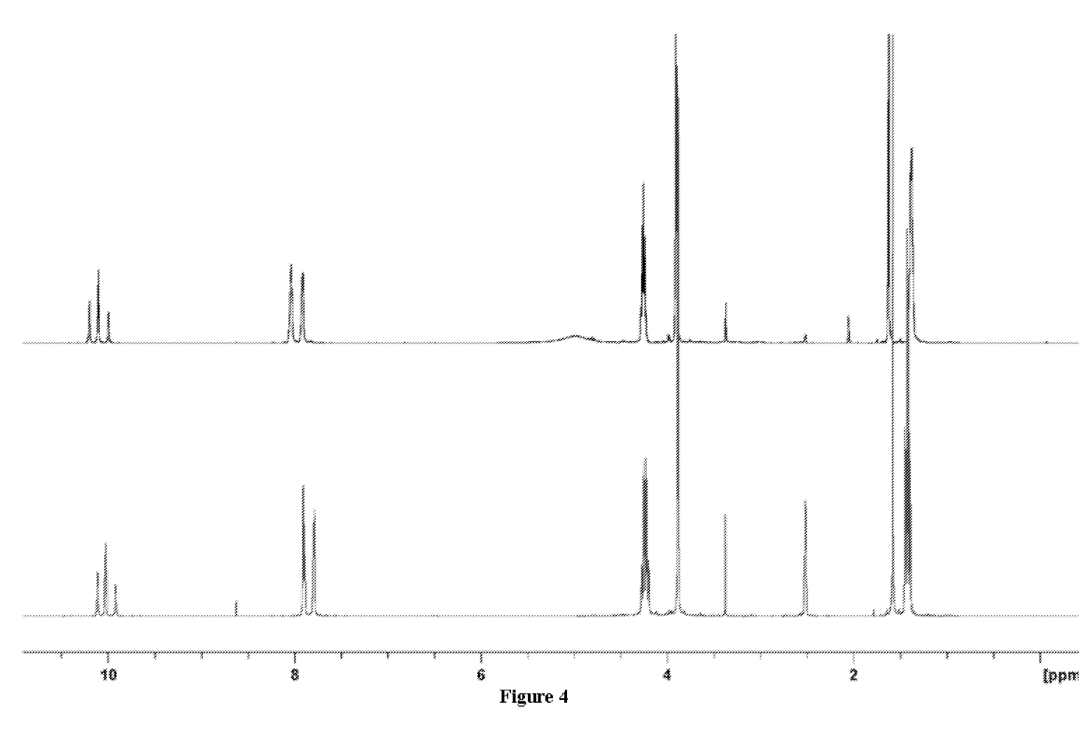

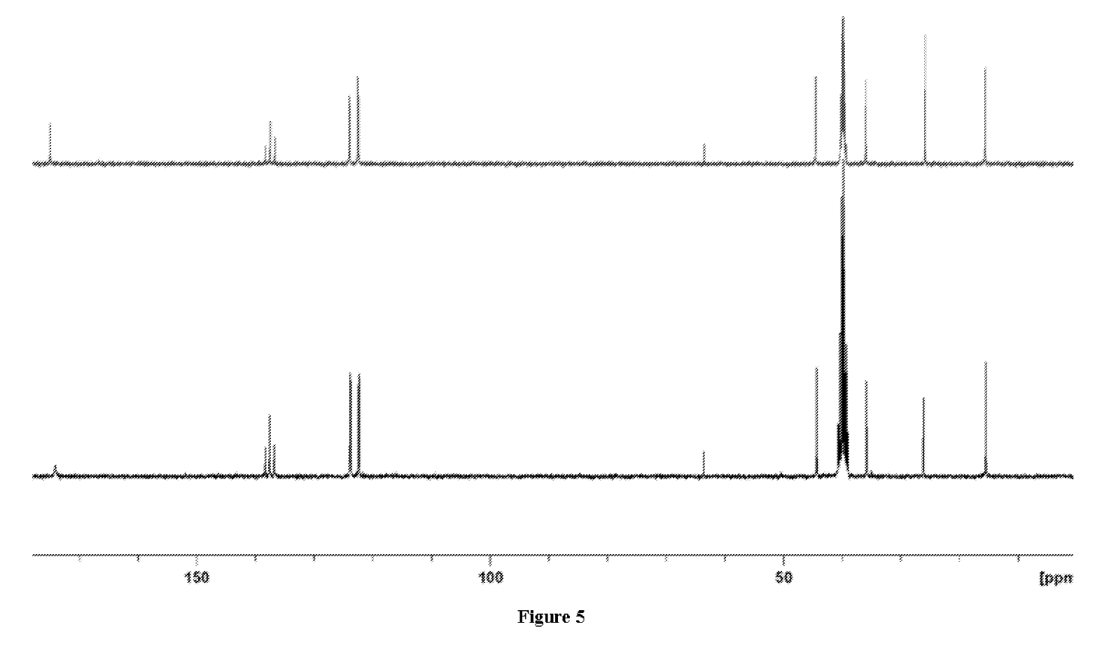

In some aspects, the disclosed mixtures perform better at dissolving biomass than single-ionic liquid counterparts. For example, it was found that cellulose displays higher solubility in ternary mixtures of dialkylated imidazolium ionic liquids than in a single ionic liquid of the mixture alone. In a specific example, it was found that an inexpensive 2:1:1 mixture of 1-ethyl-3-methylimidazolium, 1,3-diethylimidazolium, and 1,3-dimethylimidazolium acetate can dissolve up to about 5 weight percent cellulose at room temperature and up to about 35 weight percent cellulose (when heated) before the solution becomes very viscous, with no decomposition of the ionic liquid mixture observed during the dissolution process (the ¹H and ¹³C NMR of ILs mixture/cellulose solution shows the same chemical shift and peak integrated ratio as in the neat ILs mixture, see FIGS. 4 and 5). The cellulose used in the exemplary dissolution experiments was microcrystalline cellulose (Aldrich), but can be substantially in any form, from fibrous cellulose, paper, cotton balls, to wood pulp.

In a specific example of the method, a polymer is completely or partially dissolved or suspended in an IL at up to about 50 wt %. A processing aid can already be present in the IL or can be added after the polymer is dissolved. Catalysts and any optional additives can be used to increase dissolution, facilitate disintegration, cleave bonds, separate biopolymers from biomass, and for derivatization and other treatments of polymers and their components.

The components of a polymer mixture, such as biomass for example, can be dissolved simultaneously (or selectively) and optionally regenerated separately later using appropriate regeneration solvents. Likewise, the processing aids can be recovered from the solution and re-used. Processing aids can be added to the system in order to stiochiometrically/nonstoichiometrically interact with polymer components to increase dissolution, facilitate disintegration, cleave bonds, delignifying, fermentate, separate biopolymers from biomass, and for derivatization and other treatments of polymers and their components. Any processing aid can be used in these methods as long as the ionic liquid media does not inactivate the processing aid. When the polymer is present in biomass, for example, suitable processing aids are those that can selectively cleave lignin from lignocellulosic biomass or degrade a biopolymer component of biomass (e.g., fermentation of sugars into ethanol). Some specific examples of processing aids, include but are not limited to, catalysts, metal salts, polyoxymetalates (POMs) (e.g. H₅[PV₂Mo₁₀O₄₀]), anthraquinone, enzymes, and the like. Dichloro dicyano quinone (DDQ) is an example of one type of processing aid that can selectively cleave lignocellulosic bonds in solution and help separating components of lignocellulosic biomass. In many examples, the processing aid is not an acid catalyst.

Polymers

The disclosed mixtures of ionic liquids can be useful in dissolving and/or processing a variety of polymers. Thus, in some aspects, the disclosed mixtures of ionic liquids and polymers are present in a composition. A wide range of polymer amounts, relative to the composition, can be effectively dissolved and/or processed, generally depending on the type of polymer, the processing temperature, and the processing time. In various aspects, the mixture comprises the polymer in an amount up to about 50% by weight of the mixture, up to about 35% by weight of the mixture, up to about 25% by weight of the mixture, up to about 10% by weight of the mixture, or up to about 5% by weight of the mixture. Any minimum amount of polymer can be present, for example, 0.1%, 1%, or 2%.

Biopolymers

When the polymers are biopolymers, the biopolymer can be any biopolymer either in a processed, derivatized, pure, or unpure form. Non-limiting examples of biopolymers include without limitation starch, pectin, chitin, chitosan, alginate, cellulose, or a mixture thereof. In some examples the biopolymers can be lignin and hemicelluloses bonded or unbonded lignocellulosic biomass. In a preferred aspect the biopolymer is chitin.

The biopolymer can also be present in biomass and the biomass can be mixed directly with the ionic liquid mixtures. Thus, disclosed are compositions comprising biomass and the ionic liquid mixture. Also disclosed are methods for dissolving biomass in the ionic liquid mixtures. In this aspect, the biomass used can be fractioned, treated, derivitized, and/or otherwise processed. The term “biomass,” as used herein, refers to living or dead biological material that can be used in one or more of the disclosed processes. Biomass can comprise any cellulosic or lignocellulosic material and includes materials comprising cellulose, and optionally further comprising hemicellulose, lignin, starch, oligosaccharides and/or monosaccharides, biopolymers, natural derivatives of biopolymers, their mixtures, and breakdown products (e.g., metabolites). Biomass can also comprise additional components, such as protein and/or lipid. Biomass can be derived from a single source, or biomass can comprise a mixture derived from more than one source. Some specific examples of biomass include, but are not limited to, bioenergy crops, agricultural residues, municipal solid waste, industrial solid waste, sludge from paper manufacture, yard waste, wood and forestry waste. Additional examples of biomass include, but are not limited to, corn grain, corn cobs, crop residues such as corn husks, corn stover, grasses, wheat, wheat straw, hay, rice straw, switchgrass, waste paper, sugar cane bagasse, sorghum, soy, components obtained from milling of grains, trees (e.g., pine), branches, roots, leaves, wood chips, wood pulp, sawdust, shrubs and bushes, vegetables, fruits, flowers, animal manure, multi-component feed, and crustacean biomass (e.g., chitinous biomass from shellfish, shrimp and/or crab shells).

Lignocellulosic biomass typically comprises of three major components: cellulose, hemicellulose, and lignin, along with some extractive materials (Sjostorm, E. Wood Chemistry: Fundamentals and Applications, 2nd ed., 1993, New York.). Depending on the source, their relative compositions usually vary to certain extent. Cellulose is the most abundant polymer on Earth and enormous effort has been put into understanding its structure, biosynthesis, function, and degradation (Stick, R. V. Carbohydrates—The Sweet Molecules of Life, 2001, Academic Press, New York.). Cellulose is actually a polysaccharide consisting of linear chain of several hundred to over ten thousand β(1→4) linked D-glucose units. The chains are hydrogen bonded either in parallel or anti-parallel manner which imparts more rigidity to the structure, and a subsequent packaging of bound-chains into microfibrils forms the ultimate building material of the nature.

Hemicellulose is the principal non-cellulosic polysaccharide in lignocellulosic biomass. Hemicellulose is a branched heteropolymer, consisting of different sugar monomers with 500-3000 units. Hemicellulose is usually amorphous and has higher reactivity than the glucose residue because of different ring structures and ring configurations. Lignin is the most complex naturally occurring high-molecular weight polymer (Hon, D. N. S.; Shiraishi, N., Eds., Wood and Cellulosic Chemistry, 2nd ed., 2001, Marcel Dekker, Inc., New York.). Lignin relatively hydrophobic and aromatic in nature, but lacks a defined primary structure. Softwood lignin primarily comprises guaiacyl units, and hardwood lignin comprises both guaiacyl and syringyl units. Cellulose content in both hardwood and softwood is about 43±2%. Typical hemicellulose content in wood is about 28-35 wt %, depending on type of wood. Lignin content in hardwood is about 18-25% while softwood may contain about 25-35% of lignin.

Chitin is a polymer of N-acetyl-D-glucosamine and has a similar structure to cellulose. It is an abundant polysaccharide in nature, comprising the horny substance in the exoskeletons of crab, shrimp, lobster, cuttlefish, and insects as well as fungi. Any of these or other sources of chitin are suitable for use in the methods and compositions disclosed herein. In addition to chitin, chitin derivatives can be used. One such derivative is chitosan. Chitosan is a de-acetylated form of chitin and occurs naturally in some fungi.

Ionic liquids can possess an extremely strong hydrogen bond basicity necessary to disrupt the hydrogen bonding network of natural biopolymers like those mentioned herein. In addition to the effective dissolution and easy regeneration of biopolymers by precipitation, upon addition of water or other common solvents, ionic liquids also prevent their degradation.

Synthetic Polymers

As discussed above, the ionic liquid mixtures can also be used to dissolve and/or process synthetic polymers. In one aspect, the synthetic polymer can comprise hydrogen bond donors and/or hydrogen bond acceptors. Examples of such polymers include those comprising hydroxyl, amino, amido, carbonyl, or ester functional groups, for example. In some aspects, the ionic liquid mixtures are not suitable for dissolving polymers that do not comprise hydrogen bond donors or hydrogen bond acceptors, such as, for example, polypropylene or polyethylene. Non-limiting examples of synthetic polymers that can be used in combination with the disclosed methods and compositions include without limitation polyethylene glycol, polypropylene glycol, polyethyleneamine, poly-2-hydroxymethylmethacrylate, poly-2-hydroxyethylmethacrylate, polyamides, polyesters, polyimideamides, polybenzoimide, aramides, polyimides, polyvinyl alcohol, polyaniline, polyacrylonitrile, polyethyleneimine, or a combination thereof.

The biopolymers or synthetic polymers, once dissolved, can regenerated or can be used to prepare other articles or compositions comprising other components. For example, nanoparticle containing sheets or films can be prepared using the disclosed ionic liquid mixtures according to the methods described in U.S. Pat. No. 7,550,520 to Daly et al., which is incorporated herein by this reference for its teachings of nanoparticle sheet or film production. The polymer can also be regerated using the disclosed mixtures. For example, methods for dissolving and/or regenerated cellulose using the disclosed ionic liquid mixtures can be carried out according the methods described in U.S. Pat. No. 6,824,599 to Swatlowski et al., which is incorporated herein by this reference in its entirety for its teachings of cellulose dissolution and regeneration methods. Cellulose matrix encapsulated substances can also be prepared using the disclosed ionic liquid mixtures according to the methods described in U.S. Pat. No. 6,808,557 to Holbrey et al., which is incorporated herein by this reference for its teachings of cellulose matrix encapsulation methods. In other aspects, blends or resins can be prepared using the disclosed ionic liquid mixtures according to the methods described in U.S. Patent Application Publication No. 20050288484 to Holbrey et al., which is incorporated herein by this reference for its teachings of blend and resin formation using ionic liquids.

Ionic Liquid Mixtures

A variety of ionic liquids can be used in combination with the disclosed methods and compositions. Generally, the ionic liquids contain ionized species (i.e., cations and anions) and have melting points usually below about 100° C. Typically, the ionic liquid mixtures comprise different ionic liquids, for example, ionic liquids that comprise different cationic components. The anionic components in the mixture can be the same or different. In some cases the ionic liquids are organic salts containing one or more cations that are typically ammonium, imidazolium, or pyridinium ions; although, many other types are known and disclosed herein.

The ionic liquid mixtures, in one aspect, comprise crude ionic liquids, such as those comprising organic solvent, or even water. Such mixtures can be crude ionic liquids prepared by a one-pot process, such as those processes disclosed herein. In other aspects, the ionic liquid mixtures can be substantially free of water, a water- or alcohol-miscible organic solvent, or nitrogen-containing base, for example, <5%, <4%, <3%, <2%, or <1% weight percent. Contemplated organic solvents of which the ionic liquid is free include solvents such as dimethyl sulfoxide, dimethyl formamide, acetamide, hexamethyl phosphoramide, NMMO, water-soluble alcohols, ketones or aldehydes such as ethanol, methanol, 1- or 2-propanol, tert-butanol, acetone, methyl ethyl ketone, acetaldehyde, propionaldehyde, ethylene glycol, propylene glycol, the C₁-C₄ alkyl and alkoxy ethylene glycols and propylene glycols such as 2-methoxyethanol, 2-ethoxyethanol, 2-butoxyethanol, diethyleneglycol, and the like.

The ionic liquid mixtures can comprise different cations, different anions, or both. A cation of the ionic liquids in the mixture can be cyclic and correspond in structure to a formula shown below:

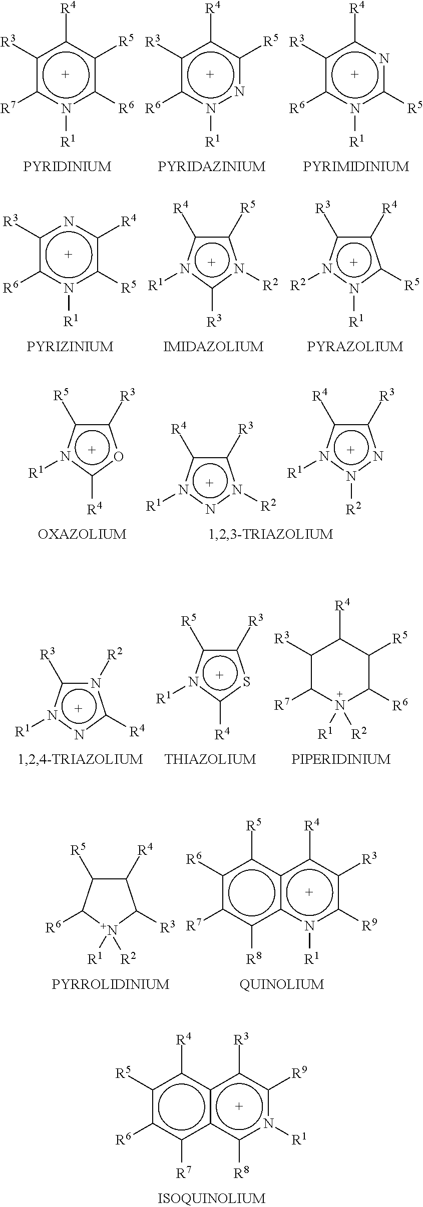

wherein R¹ and R² are independently a C₁-C₆ alkyl group or a C₁-C₆ alkoxyalkyl group, and R³, R⁴, R⁵, R⁶, R⁷, R⁸, and R⁹ (R³-R⁹), when present, are independently H, a C₁-C₆ alkyl, a C₁-C₆ alkoxyalkyl group, or a C₁-C₆ alkoxy group. In other examples, both R¹ and R² groups are C₁-C₄ alkyl, with one being methyl, and R³-R⁹, when present, are H. Exemplary C₁-C₆ alkyl groups and C₁-C₄ alkyl groups include methyl, ethyl, propyl, iso-propyl, butyl, sec-butyl, iso-butyl, pentyl, iso-pentyl, hexyl, 2-ethylbutyl, 2-methylpentyl, and the like. Corresponding C₁-C₆ alkoxy groups contain the above C₁-C₆ alkyl group bonded to an oxygen atom that is also bonded to the cation ring. An alkoxyalkyl group contains an ether group bonded to an alkyl group, and here contains a total of up to six carbon atoms. It is to be noted that there are two iosmeric 1,2,3-triazoles. In some examples, all R groups not required for cation formation can be H.

In one example, all R groups that are not required for cation formation; i.e., those other than R¹ and R² for compounds other than the imidazolium, pyrazolium, and triazolium cations shown above, are H. Thus, the cations shown above can have a structure that corresponds to a structure shown below, wherein R¹ and R² are as described before.

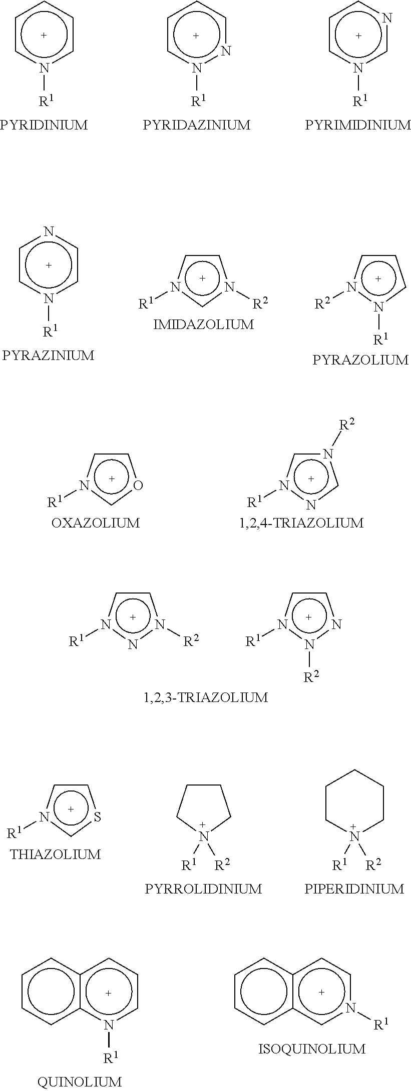

A cation that contains a single five-membered ring that is free of fusion to other ring structures is suitable for use herein. Exemplary cations are illustrated below wherein R¹, R², and R³-R⁵, when present, are as defined before.

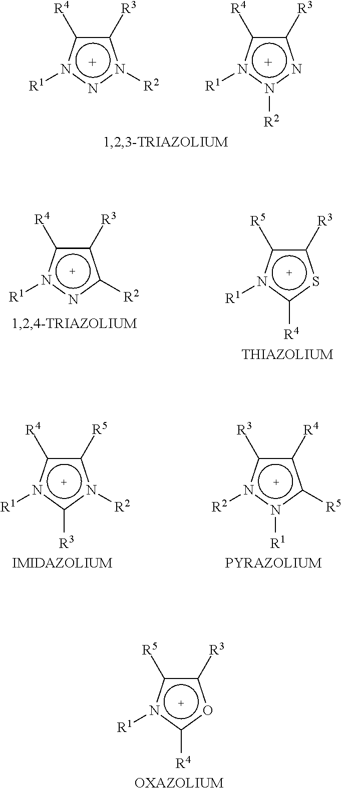

Of the cations that contain a single five-membered ring free of fusion to other ring structures, an imidazolium cation that corresponds in structure to Formula A is preferred, wherein R¹, R², and R³-R⁵, are as defined before.

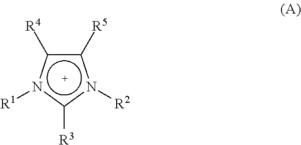

In a further example, an N,N-1,3-di-(C₁-C₆ alkyl)-substituted-imidazolium ion can be used; i.e., an imidazolium cation wherein R³-R⁵ of Formula A are each H, and R¹ and R² are independently each a C₁-C₆ alkyl group or a C₁-C₆ alkoxyalkyl group. In yet another example, the cation illustrated by a compound that corresponds in structure to Formula B, below, wherein R³ -R⁵ of Formula A are each hydrido and R¹ is a C₁-C₆ -alkyl group or a C₁-C₆ alkoxyalkyl group. In this example, each ionic liquid in the mixture comprises different R¹, R², or R¹ and R² groups. The anions of ionic liquids can be halogens or C₁-C₆ carboxylate.

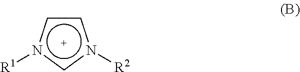

In one specific aspect, the mixture comprises mixture a, b, or c shown below:

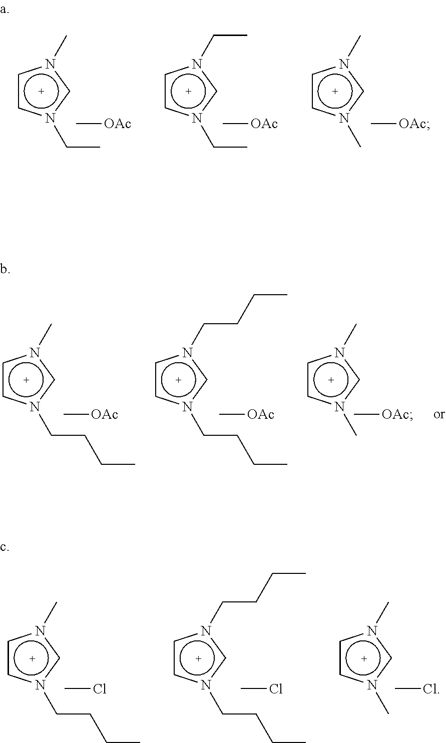

The counterions in the mixtures of the different ionic liquids can be the same or different, as discussed above. In the above examples, the counterions are the same. In other examples, the counterions are not the same.

The disclosed ionic liquids can be liquid at or below a temperature of about 150° C., for example, at or below a temperature of about 100° C. and at or above a temperature of about minus 100° C. For example, N-alkylisoquinolinium and N-alkylquinolinium halide salts have melting points of less than about 150° C. The melting point of N-methylisoquinolinium chloride is 183° C., and N-ethylquinolinium iodide has a melting point of 158° C. In other examples, a contemplated ionic liquid is liquid (molten) at or below a temperature of about 120° C. and above a temperature of about minus 44° C. In some examples, a suitable ionic liquid can be liquid (molten) at a temperature of about minus 10° C. to about 100° C.

An ionic liquid as disclosed herein can have an extremely low vapor pressure and typically decomposes prior to boiling. Exemplary liquification temperatures (i.e., melting points (MP) and glass transition temperatures (T_{g})) and decomposition temperatures for illustrative N,N-1,3-di-C₁-C₆ -alkyl imidazolium ion-containing ionic liquids wherein one of R¹ and R² is methyl are shown in Table 1 below, wherein Cₓmim refers to 1-Cₓ-3-methyl-imidazolium ion.

TABLE 1

| | Liquification | Decomposition | |
|---|---|---|---|
| | Temperature | Temperature | |
| Ionic Liquid | (° C.) | (° C.) | Citation* |
| [C₂mim] Cl | | 285 | a |
| [C₃mim] Cl | | 282 | a |
| [C₄mim] Cl | 41 | 254 | b |
| [C₆mim] Cl | −69 | 253 | |
| [C₈mim] Cl | −73 | 243 | |
| [C₂mim] I | | 303 | a |
| [C₄mim] I | −72 | 265 | b |
| [C₂mim] [C₂H₃O₂] | 45 | | c |
| [C₂mim] [C₂F₃O₂] | 14 | About 150 | f |
| [m₂im] [C₂H₃O₂] | | 248 | g |
| [C₂C₂im] [C₂H₃O₂] | 30 | 245 | g |

a) Ngo et al., Thermochim Acta 2000, 357: 97.
b) Fanniri et al., J Phys Chem 1984, 88: 2614.
c) Wilkes et al., Chem Commun 1992, 965.
d) Suarez et al., J Chim Phys 1998, 95: 1626.
e) Holbrey et al., J Chem Soc, Dalton Trans 1999, 2133.
f) Bonhote et al., Inorg Chem 1996, 35: 1168.
g) m₂im is dimethyl imidazolium and C₂C₂im is diethylimidazolium.

The choice of the counterion in the ionic liquid can be particularly relevant to the rate and level of polymer dissolution. While not wishing to be bound by theory, the primary mechanism of solvation of many polymers by an ionic liquid is the anion's ability to break the extensive hydrogen-bonding networks by specific interactions with hydroxyl groups. Thus, it is believed that that the dissolution is enhanced by increasing the hydrogen bond acceptance and basicity of the anion. Anions that lower the hydrogen bond bascicity (i.e., add hydrogen bond donors) in too great of an excess should be avoided. Anions that also form less viscous ionic liquids are also preferred. Accordingly, preferred anions are substituted or unsubstituted acyl units R¹⁰CO₂, for example, formate HCO₂, acetate CH₃CO₂, proprionate, CH₃CH₂CO₂, butyrate CH₃CH₂CH₂CO₂, and benzylate, C₆H₅CO₂; substituted or unsubstituted sulfates: (R¹⁰O)S(═O)₂O; substituted or unsubstituted sulfonates R¹⁰SO₃, for example (CF₃)SO₃; substituted or unsubstituted phosphates: (R¹⁰O)₂P(═O)O; and substituted or unsubstituted carboxylates: (R¹⁰O)C(═O)O. Non-limiting examples of le include hydrogen; substituted or unsubstituted linear branched, and cyclic alkyl; substituted or unsubstituted linear, branched, and cyclic alkoxy; substituted or unsubstituted aryl; substituted or unsubstituted aryloxy; substituted or unsubstituted heterocyclic; substituted or unsubstituted heteroaryl; acyl; silyl; boryl; phosphino; amino; thio; and seleno. In especially preferred embodiuments, the anion is C₁₋₆ carboxylate.

Still further examples of preferred counterions are deprotonated amino acids, for example, Isoleucine, Alanine, Leucine, Asparagine, Lysine, Aspartic Acid, Methionine, Cysteine, Phenylalanine, Glutamic Acid, Threonine, Glutamine, Tryptophan, Glycine, Valine, Proline, Selenocysteine, Serine, Tyrosine, Arginine, Histidine, Ornithine, Taurine.

It is also contemplated that other counterions, though not preferred, can still be used in some instances. However, in these instances, higher concentrations, longer mixing times, and higher temperatures can be required. One can use halogens, (i.e., F, Cl, Br, and I), CO₃²; NO₂⁻, NO₃⁻, SO₄², CN⁻, arsenate(V), AsX₆; AsF₆, and the like; stibate(V) (antimony), SbX₆; SbF₆, and the like.

A suitable anion for a contemplated ionic liquid cation is a halogen (fluoride, chloride, bromide, or iodide), perchlorate, a pseudohalogen such as thiocyanate and cyanate or C₁-C₆ carboxylate. Pseudohalides are monovalent and have properties similar to those of halides (Schriver et al., Inorganic Chemistry, W. H. Freeman & Co., New York, 1990, 406-407). Pseudohalides include the cyanide (CN⁻), thiocyanate (SCN⁻), cyanate (OCN⁻), fulminate (CNO⁻), and azide (N₃⁻) anions. Carboxylate anions that contain 1-6 carbon atoms (C₁-C₆ carboxylate) and are illustrated by formate, acetate, propionate, butyrate, hexanoate, maleate, fumarate, oxalate, lactate, pyruvate, and the like. Still other examples of anions that can be present in the disclosed compositions include, but are not limited to, persulfate, sulfate, sulfites, phosphates, phosphites, nitrate, nitrites, hypochlorite, chlorite, perchlorate, bicarbonates, and the like, including mixtures thereof.

The ionic liquid mixtures, in some aspects, can have improved room temperature conductivity compared to single ionic liquids. In one aspect, the mixture has a room temperature conductivity of 2.4 mS/cm or greater, for example, from 2.4 mS/cm to 3 mS/cm. For example, it was also found that the salts composed of three dialkylated imidazolium cations and an anion manifest higher ionic conductivity than a single ionic liquid of the mixture alone. It is known that higher ionic conductivities allow an electrochemical power source to deliver more power, in addition to enabling low temperature applications. Therefore, the disclosed mixtures of dialkylated imidazolium ionic liquids, for example, can find applications in many industrial fields, as a replacement for conventional electrolytes.

Additionally, the ionic liquid mixtures have a number of other improved properties relative to a single ionic liquid counterpart. Table 2 shows comparisons between some exemplary disclosed ionic liquid mixtures and single ionic liquid counterparts.

TABLE 2
Characterization and comparison of pure and mixture
(obtained via 1-pot method) ionic liquids

| | | Water | Conductivity | Viscosity | Density | T_{5%} |
|---|---|---|---|---|---|---|
| | mp | content^{a} | at RT, | at RT, | at RT | onset |
| Ionic Liquid | (° C.) | (ppm) | mS/cm | cP | (g/mL) | (° C.) |
| [C₂mim][OAc]^{b} | ≦−20 | Not | 2.36 | 93 | 1.027 | 150 |
| | | measured | | | | |
| [C₂C₂im][OAc] | 30 | Not | | | 1.0729 | 203.03 |
| | | measured | | | | |
| 2:1:1 mixture of | — | 1560^{c} | 2.70 | 239.2 | 1.291 | 220 |
| [C₂mim], [di- | | | | | | |
| C₂im], and [di- | | | | | | |
| mim][OAc] | | | | | | |
| [C₄mim][OAc]^{d} | ≦−20 | 1044 | 1.1 | 440 | 1.053 | 191.7 |
| 2:1:1 mixture of | — | 2365^{e} | 2.88 | 97.5 | Not | 215 |
| [C₄mim], [di- | | | | | measured | |
| C₄im], and [di- | | | | | | |
| mim][OAc] | | | | | | |
| [C₄mim]Cl^{d} | 41 | 2200 | — | — | 1.080 | 254 |
| 2:1:1 mixture of | — | 2488e^{e} | — | 299.1 | Not | 255 |
| [C₄mim], [di- | | | | | measured | |
| C₄im], and [di- | | | | | | |
| mim]Cl | | | | | | |

^{a}Karl-Fisher titration.
^{c}Synthesized and vacuum dried.
^{d}Data taken from Ionic Liquid Database—IL Thermo.
^{e}Synthesized and freeze dried.

The ionic liquid mixtures can comprise any number of ionic liquids having different cations and/or anions. In one aspect, at least 2 different ionic liquids are present. For example, mixtures comprising 2, 3, 4, 5, 6, 7, 8, or more different ionic liquids can be used. The ionic liquids can be present in any desired ratio. For example, when three different ionic liquids are present, the ionic liquids can be present at a ratio of about 1:1:1, 2:1:1, or 3:1:1, among others. The choice of ionic liquid used is based on the particular biopolymer or synthetic polymer that one seeks to dissolve.

Processing Aids

Processing aids can be added to the system in order to help lower the cost, lower the viscosity, aid in recycling, stiochiometrically/nonstoichiometrically interact with polymer components to increase dissolution, facilitate disintegration, cleave bonds, delignifying, fermentate, separate biopolymers from biomass, and for derivatization and other treatments of biomass and their components. Any processing aid can be used in these methods as long as the ionic liquid media does not inactivate the processing aid. Suitable processing aids are those that can selectively cleave lignin from lignocellulosic biomass or degrade a biopolymer component of biomass (e.g., fermentation of sugars into ethanol). Carboxylate salts such as sodium, potassium, ammonium, and choline acetates can be added to the ionic liquid mixtures to facilitate dissolution. Some other examples of processing aids, include but are not limited to, catalysts, metal salts, polyoxymetalates (POMs) (e.g., H₅ [PV₂Mo₁₀O₄₀]), anthraquinone, enzymes, and the like. Dichlorodicyanoquinone (DDQ) is an example of one type of processing aid that can selectively cleave lignocellulosic bonds in solution and help separating components of lignocellulosic biomass. In many examples, the processing aid is a metal ion catalyst used to cleave lignocellulosic bonds. Also, contemplated herein are processing aids like microwave or thermal irradiation. Such aids can likewise be used to break bonds in a biomass material present in an IL.

It is also possible to add solvents to the ionic liquid mixtures to aid in dissolution and processing. For example, glycol, polyethylene glycol, DMSO, DMF, polyvinylalcohol, polyvinylpyrrolidone, furan, pyridine and other N containing bases, and the like can be added. In some examples the ionic liquid mixtures can be mixed with polyalkylene glycols as disclosed in WO09/105236, which is incorporated by reference herein for its teaching of fractioning polymers and their use in ionic liquids.

Methods of Making the Ionic Liquid Mixtures

The mixtures comprising the different ionic liquids can be prepared according to a number of methods. In one aspect, different ionic liquids can be simply mixed together in a desired ratio. For example, different ionic liquids separately prepared and then combined to form an ionic liquid mixture. In other aspects, the mixtures can be prepared in a one-pot method, wherein a single ionic liquid or different ionic liquids are prepared in-situ from appropriate starting materials and in the desired ratio. Suitable synthetic methods for preparing the ionic liquids are known in the art. For example, suitable synthetic routes are described in U.S. Pat. No. 5,077,414 to Arduengo and U.S. Pat. No. 7,253,289 to Ren, each of which is incorporated herein by this reference in its entirety for its teachings of ionic liquid synthesis. The mixtures can be prepared using a one-pot synthesis. The one-pot synthesis is amenable to a continuous process, which will decrease the cost of the solvent used for cellulose dissolution. By “one-pot,” it is meant that all reagents to prepare the ionic liquids are added into a single vessel, and the subsequent reaction results in the mixture of ionic liquids, which will typically be a statistical mixture.

In one example, an imidazolium-based ternary mixture can be prepared according to Scheme 1:

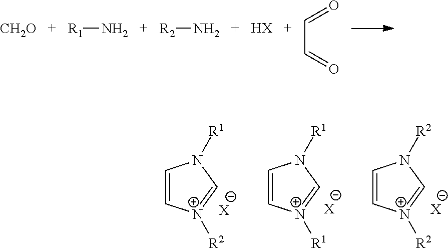

wherein X is any suitable anion, such as those discussed above, and wherein R¹NH₂ and R²NH₂ are different. The route shown in Scheme 1 above can be modified using more or different amines in various ratios to provide a wide range of ionic liquid mixtures. With reference to FIG. 1, for example, a process such as the one shown above in Scheme 1 can be a continuous process on a large-scale, wherein the various components are mixed together and reacted. The filtration station shown in FIG. 1 is optional, but can be used, for example, if color removal is desirable. Scheme 1 can also be modified where R¹NH₂ and R²NH₂ are the same. This will provide a single imidazolium ion.

Compositions

Also disclosed are compositions that comprise a mixture of ionic liquids, as discussed above, and one or more polymers, as discussed above. The compositions can be prepared according to the disclosed methods, wherein the mixture is contacted with the polymer to provide the composition. Thus, in some aspects, the compositions are prepared according to the disclosed methods for dissolving polymers. Any of the processing conditions set for above can be used when preparing the compositions.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

### Synthesis of 2:1:1 Statistical Mixture of 1-ethyl-3-methylimidazolium, 1,3-diethylimidazolium, and 1,3-dimethylimidazolium acetate

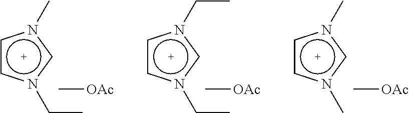

Aqueous formaldehyde (37%) (49.8 mL, 0.6 mol) was cooled in a 500 mL round bottom flask in an ice-salt bath. Aqueous ethylamine (70%) (57.7 mL, 0.6 mol) was added drop wise. The mixture was stirred for 1 1/2 hour, followed by the addition of aqueous methylamine (40%) (53.5 mL, 0.6 mol), while maintaining the temperature below 5° C. Glacial acetic acid (99-100%) (38.1 mL, 0.6 mol) was added in small portions while keeping the reaction temperature below 0° C. After the addition was complete, aqueous glyoxal (40%) (76.1 mL, 0.6 mol) was added drop wise and the resulting mixture was allowed to reach room temperature and stir for 1 1/2 days. The mixture was extracted with ethyl acetate to remove any unreacted starting materials, and the water was removed under reduced pressure yielding a light orange solution, which was purified as described in the literature (Earle et al. Anal. Chem, 2007, 79, 758-764). After purification 80 g (70% yield) faint yellow liquid was obtained (98% purity by NMR). The ¹H, ¹³C NMR confirmed the presence of a 2:1:1 mixture of 1-ethyl-3-methylimidazolium acetate, 1,3-diethylimidazolium acetate, and 1,3-dimethylimidazolium acetate, respectively. The reaction time can be reduced by increasing the temperature of the process, even though this will yield a darker mixture which will require successive purification. ¹H NMR (300 MHz, DMSO-d₆) δ(ppm)=10.11 (s, 0.5H), 10.02 (s, 1H), 9.91 (s, 0.5H), 7.91-7.78 (m, 4H), 4.24 (q, J=7.31Hz, 2H), 4.23 (q, J=7.31 Hz, 2H), 3.88 (s, 3H), 3.87 (s, 3H), 1.58 (s, 6H), 1.43 (t, J=7.31 Hz, 3H), 1.42 (t, J=7.31 Hz, 3H). ¹³C NMR (75 MHz, DMSO-d₆) δ(ppm)=174.2, 138.3, 137.6, 136.8, 123.9, 123.7, 122.4, 122.3, 44.4, 44.3, 35.9, 35.8, 26.1, 15.6, 15.5.

### Example 2

### Synthesis of 2:1:1 Statistical Mixture of 1-butyl-3-methylimidazolium, 1,3-dibutylimidazolium, and 1,3-dimethylimidazolium acetate

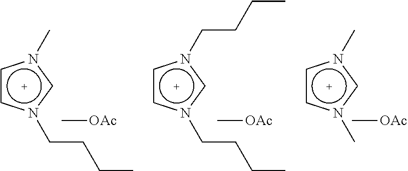

Aqueous formaldehyde (37%) (25 mL, 0.3 mol) was cooled in a 250 mL round bottom flask in an ice-salt bath. Butylamine (99.5%) (33.2mL, 0.3 mol) was added drop wise. The mixture was heated to 70° C., stirred for 15 minutes, and then cooled to 5° C. Aqueous methylamine (40%) (28 mL, 0.3 mol) was then added in small portions, while maintaining the temperature between 0-5° C. After the addition was complete, the mixture was stirred for 1 hour at 70° C., and then cooled to 5° C. by means of an ice bath. Glacial acetic acid (99-100%) (19.1 mL, 0.3 mol) was added drop wise while keeping the reaction temperature below 10° C. The mixture was heated for additional 10 minutes, and after it was cooled to 5° C., aqueous glyoxal (40%) (38.0 mL, 0.3 mol) was added drop wise and the resulting mixture was heated at 75° C. for 12 hours. The crude mixture was extracted with ethyl acetate to remove any unreacted starting materials, and the water was removed under reduced pressure yielding a dark brown solution, which was purified by flash chromatography as described in the previous example. After purification 45 g (68% yield) light orange liquid was obtained (97% purity by NMR). The ¹H, ¹³C NMR confirmed the presence of a 2:1:1 mixture of 1-butyl-3-methylimidazolium acetate, 1,3-dibutylimidazolium acetate, and 1,3-dimethylimidazolium acetate, respectively. The reaction can be optimized by working at low temperature, reducing thus the purification costs. ¹H NMR (300 MHz, DMSO-d₆) δ(ppm)=9.92 (s, 0.5H), 9.81 (s, 1H), 9.71 (s, 0.5H), 7.87 (d, J=1.5 Hz, 1H), 7.84 (t, J=1.79 Hz, 1H), 7.77 (t, J=1.79 Hz, 1H), 7.74 (d, J=1.5 Hz, 1H), 4.19 (t, J=7.06 Hz, 2H), 4.18 (t, J=7.15 Hz, 2H), 3.87 (s, 3H), 3.86 (s, 3H), 1.76 (quintet, J=7.35 Hz, 2H), 1.75 (quintet, J=7.48 Hz, 2H), 1.62 (s, 6H) 1.23 (sext, J=7.53 Hz, 2H), 1.22 (sext, J=7.49 Hz, 2H), 0.87 (t, J=7.34 Hz, 6H).

### Example 3

### Synthesis of 2:1:1 statistical mixture of 1-butyl-3-methylimidazolium, 1,3-dibutylimidazolium, and 1,3-dimethylimidazolium chloride

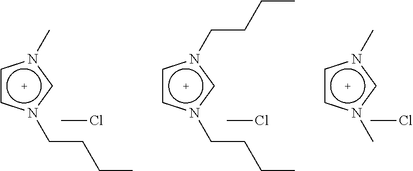

Butylamine (99.5%) (33 mL, 0.3 mol) was added drop wise to a cooled suspension of paraformaldehyde (10 g, 0.3 mol) in 50 mL toluene. The mixture was allowed to warm up to room temperature and slowly increased (by means of a heatgun) to 80° C., when the entire solid dissolved. Upon cooling to 5° C., methylamine hydrochloride (22.4 g, 0.3 mol) was added in small portions. After the addition was complete, the mixture was stirred for 15 minutes. The temperature was increased to 40° C. and then slowly to 95° C. when everything dissolved. After 10 minutes, the faint yellow solution was cooled to 5° C. and glyoxal (38.0 mL, 0.3 mol) was added drop wise, while maintaining the reaction temperature below 5° C. With glyoxal addition, the solution changed its color from light to dark yellow. After overnight stirring, the layers were separated and the water was evaporated to yield a dark brown oil. The crude mixture was purified as described in example 1, yielding a light yellow oil (97% purity by NMR). The ¹H, ¹³C NMR confirmed the presence of a 2:1:1 mixture of 1-butyl-3-methylimidazolium chloride, 1,3-dibutylimidazolium chloride, and 1,3-dimethylimidazolium chloride, respectively. The reaction can be optimized by using only aqueous reagents and lowering the reaction temperature, reducing thus the process and purification costs. ¹H NMR (300 MHz, DMSO-d₆) δ(ppm)=9.88 (s, 0.5H), 9.72 (s, 1H), 9.58 (s, 0.5H), 8.01 (d, J=1.5 Hz, 1H), 7.98 (t, J=1.70 Hz, 1H), 7.89 (t, J=1.70 Hz, 1H), 7.86 (d, J=1.5 Hz, 1H), 4.22 (m, 4H), 3.89 (s, 3H), 3.88 (s, 3H), 1.74 (m, 4H), 1.20 (sext, J=7.42 Hz, 2H), 1.9 (sext, J=7.42 Hz, 2H), 0.83 (t, J=7.34 Hz, 6H).

### Example 4

### Dissolution of Cellulose in 2:1:1 Statistical Mixture of 1-ethyl-3-methylimidazolium, 1,3-diethylimidazolium, and 1,3-dimethylimidazolium acetate

Microcrystalline cellulose (0.002 g) was placed in the title mixture (2 g) in a glass vial and the resulting mixture was stirred at room temperature until complete dissolution was observed. Solutions can be prepared in this manner with varying concentration of up to 5 weight percent of cellulose. The viscous solution was heated (by means of an oil bath) at 100° C., when became clear. Small increments of cellulose were added gradually and stirred until complete dissolution was observed. The solution was increasingly viscous with cellulose concentration. At 35 weight percent of cellulose a viscous gel was formed. The solubility of cellulose and the rate of dissolution can be accelerated by microwave pulses.

### Example 5

### Dissolution of Cellulose in 2:1:1 Statistical Mixture of 1-butyl-3-methylimidazolium, 1,3-dibutylimidazolium, and 1,3-dimethylimidazolium chloride

Microcrystalline cellulose (0.01 g) was placed in the title mixture (1.5 g) in a glass vial and the resulting mixture was stirred at room temperature until complete dissolution was observed. Solutions can be prepared in this manner with varying concentration of up to about 5 weight percent of cellulose. The viscous solution was heated (by means of an oil bath) at 100° C., when became clear. Small increments of cellulose were added gradually and stirred until complete dissolution was observed. The solution was increasingly viscous with cellulose concentration. At 25 weight percent of cellulose a viscous gel was formed. The solubility of cellulose and the rate of dissolution can be accelerated by microwave pulses.

### Example 6

### Dissolution of Chitin in 2:1:1 Statistical Mixture of 1-ethyl-3-methylimidazolium, 1,3-diethylimidazolium, and 1,3-dimethylimidazolium acetate

0.032 g of chitin (practical grade) was added portion wise to 2 g of the one-pot 2:1:1 mixture of [C2mim], [di-C2im], and [di-mim][OAc]. Complete dissolution was observed after 60×3s pulses (3 minutes) microwave heating. Based on the amount of [C2mim][OAc] contained in the mixture (1 g), the weight percentage of chitin dissolved in the mixture (3.1%) is 1.6 times higher than the one in commercially available [C2mim][OAc] (1.96%).

### Example 7

### Ionic Conductivity and Viscosity Measurements

Room temperature (25° C.) conductivities and viscosities were measured of neat solutions of 1-ethyl-3-methylimidazolium acetate ([C₂mim][OAc_{c}]), 2:1:1 mixture of 1-ethyl-3-methylimidazolium (C₂mim), 1,3-diethylimidazolium (di-C₂im), and 1,3-dimethylimidazolium (di-mim) acetate, 2:1:1 mixture of 1-butyl-3-methylimidazolium (C₄mim), 1,3-dibutylimidazolium (di-C₄im), and 1,3-dimethylimidazolium (di-mim) chloride and a 2:1:1 mixture of 1-butyl-3-methylimidazolium (C₄mim), 1,3-dibutylimidazolium (di-C₄im), and 1,3-dimethylimidazolium (di-mim) acetate. 2:1:1 mixtures of 1-ethyl-3-methylimidazolium, 1,3-diethylimidazolium, and 1,3-dimethylimidazolium acetate manifests higher room temperature conductivity than 1-ethyl-3-methylimidazolium acetate alone.

TABLE 2

| | Water content^{a} | Conductivity, | |
|---|---|---|---|
| Ionic Liquid | (ppm) | mS/cm | Viscosity, cP |
| [C₂mim][OAc] | | 2.36 | — |
| 2:1:1 mixture of | 1560^{b} | 2.70 | 239.2 |
| [C₂mim], [di-C₂im], | | | |
| and [di-mim][OAc] | | | |
| 2:1:1 mixture of | 2365^{c} | 2.88 | 97.5 |
| [C₄mim], [di-C₄im], | | | |
| and [di-mim][OAc] | | | |
| 2:1:1 mixture of | 2488^{c} | — | 299.1 |
| [C₄mim], [di-C₄im], | | | |
| and [di-mim]Cl | | | |

^{a}Karl-Fisher titration.
^{b}Synthesized and vacuum dried.
^{c}Synthesized and freeze dried.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A method for dissolving a polymer, comprising:
a. contacting the polymer with a mixture of ionic liquids to provide a composition of polymer and the mixture;
wherein the polymer is a biopolymer or synthetic polymer;
wherein the mixture of ionic liquids comprises ionic liquids having different cations and/or anions and wherein the mixture of ionic liquids is prepared by a process comprising reacting ionic liquid precursors in one-pot to form the ionic liquids; and
b. at least partially dissolving the polymer in the mixture.

2. The method of claim 1, wherein the polymer is a biopolymer comprising starch, pectin, chitin, chitosan, alginate, silk, elastin, collagen, gelatin, hemicellulose, lignin, or cellulose.

3. The method of claim 1, wherein the polymer is a synthetic polymer having hydrogen bond donors and/or hydrogen bond acceptors.

4. The method of claim 3, wherein the synthetic polymer comprises polyethylene glycol, polypropylene glycol, or polyethyleneamine.

5. The method of claim 1, wherein the composition comprises the polymer in an amount up to about 50% by weight of the composition.

6. The method of claim 1, wherein the composition comprises the polymer in an amount up to about 35% by weight of the composition.

7. The method of claim 1, wherein the composition comprises the polymer in an amount up to about 25% by weight of the composition.

8. The method of claim 1, wherein the composition comprises the polymer in an amount up to about 10% by weight of the composition.

9. The method of claim 1, wherein the composition comprises the polymer in an amount up to about 5% by weight of the composition.

10. The method of claim 1, wherein step (b) comprises processing the composition at a temperature of from about 0° C. to about 250° C.

11. The method of claim 1, wherein step (b) comprises processing the composition at a temperature of from about 0° C. to about 120° C.

12. The method of claim 1, wherein step (b) comprises heating the composition at a temperature of from about 40° C. to about 120° C.

13. The method of claim 1, wherein step (b) comprises heating the composition at a temperature of from about 80° C. to about 120° C.

14. The method of claim 1, wherein step (b) comprises agitating the composition.

15. The method of claim 1, wherein step (b) comprises irradiating the composition with microwaves.

16. The method of claim 1, wherein step (b) comprises exposing the composition to ultrasound.

17. The method of claim 1, wherein step (b) comprises processing the composition from 1 to 12 hours.

18. The method of claim 1, wherein step (b) comprises processing the composition from 1 to 5 hours.

19. The method of claim 1, wherein the mixture of ionic liquids comprises two or more ionic liquids having cations selected from the group consisting of: 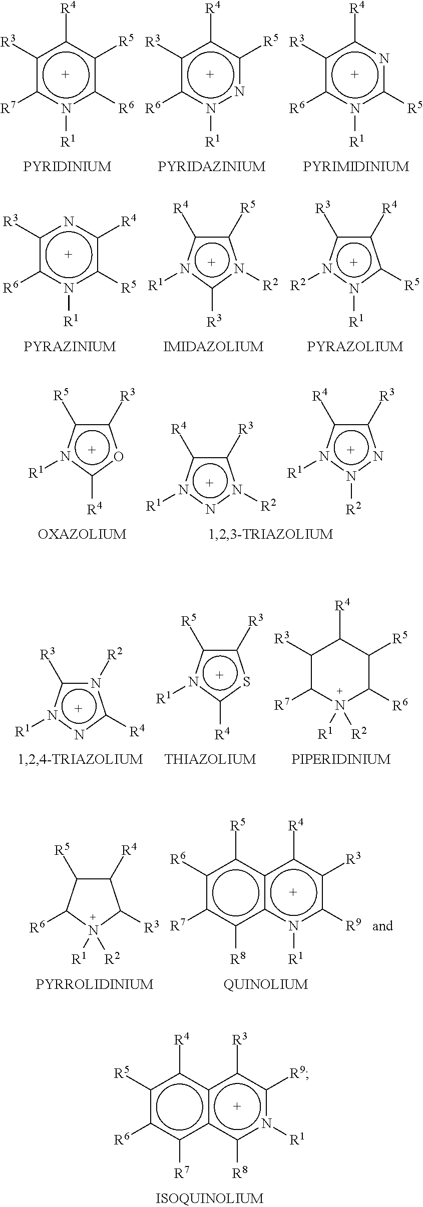
wherein R¹ and R² (when present) are independently C₁-C₆ alkyl or C₁-C₆ alkoxyalkyl, and R³, R⁴, R⁵, R⁶, R⁷, R⁸, and R⁹ (when present), are independently H, C₁-C₆ alkyl, C₁-C₆ alkoxyalkyl, or C₁-C₆ alkoxy.

20. The method of claim 19, wherein R¹ and R² (when present) are C₁-C₄ alkyl, and R³-R⁹, when present, are hydrogen.

21. The method of claim 1, wherein the mixture of ionic liquids comprises two or more cations represented by the formula: 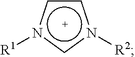
wherein R¹ and R² are independently C₁-C₆ alkyl; and wherein the two or more cations present in the mixture have different R¹, R², or R¹ and R² groups.

22. The method of claim 1, wherein the mixture of ionic liquids is:

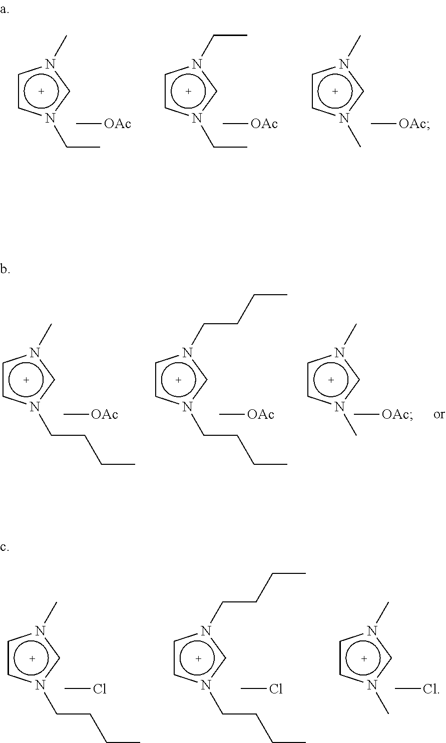

23. The method of claim 1, wherein the mixture of ionic liquids further comprises carboxylate salts.

24. The method of claim 23, wherein the carboxylate salt is sodium acetate, potassium acetate, or choline acetate.
